(19) United States
(12) Patent Application Publication
(10) Pub. No.: US 2025/0148529 A1
(43) Pub. Date: May 8, 2025

(54) Lending-Borrowing System

(71) Applicant: Jin-Hau CHANG, Taichung (TW)

(72) Inventor: Jin-Hau CHANG, Taichung (TW)

(21) Appl. No.: 18/502,284

(22) Filed: Nov. 6, 2023

(51) Int. Cl. G06Q 30/0645

(52) U.S. Cl. CPC G06Q 30/0645

(57) ABSTRACT

A lending-borrowing system has a platform. The platform has a borrowing point gaining means, a message releasing means, and a credit point gaining means. The borrowing point gaining means is applied for providing borrowing points to a member. The message releasing means is applied for a member to release a message for lending or borrowing an object. The credit point gaining means is applied for providing a credit point to each member and increasing or decreasing the credit point of the member based on conditions.

### BACKGROUND OF THE INVENTION

### 1. Field of the Invention

The present invention relates to a lending-borrowing system, and more particularly to a lending-borrowing system that can pair a lender and a borrower on line.

### 2. Description of Related Art

When a person wants to lend or borrow an object, the person has to gain or sent this object from or to the one who the person knows or the person also use on line social media to lend or borrow. However, the conventional lending-borrow way is not proceed through a third party impartial unit, so lender and the borrower do not know the credit of each other. If the lent object is lost or damaged or the lent object has flaws, a dispute will occur. Therefore, a platform that can quickly pair the lender and the borrower, let the lender and borrower know the credit of each other to keep dispute from occurring is needed.

To overcome the shortcomings, the present invention tends to provide a lending-borrowing system to mitigate or obviate the aforementioned problems.

### SUMMARY OF THE INVENTION

The main objective of the invention is to provide a lending-borrowing system that can quickly pair a lender and a borrower for an object, can let the lender and the borrower know the credit of each other to keep a dispute from occurring.

The lending-borrowing system has a platform. The platform has multiple members and has a borrowing point gaining means, message releasing means, and a credit point gaining means. The borrowing point gaining means is for providing borrowing points to each member and for transferring the borrowing points of one of the members to another one of the members when a lending-borrowing process is proceeding. The message releasing means is for one of the members to release a message for lending or borrowing an object. The credit point gaining means is for providing a credit point to each member and increasing or decreasing the credit point of the member based on conditions.

With the lending-borrowing system in accordance with the present invention, both of a lender and a borrower can peacefully proceed a lending-borrowing process based on the credit points of the both sides and transfer the borrowing points by an impartial third party to keep dispute from occurring.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of a lending-borrowing system in accordance with the present invention;

FIG. 2 is a flow chart for a lender in the lending-borrowing system in FIG. 1; and

FIG. 3 is a flow chart for a borrower in the lending-borrowing system in FIG. 1.

### DETAILED DESCRIPTION OF PREFERRED EMBODIMENT

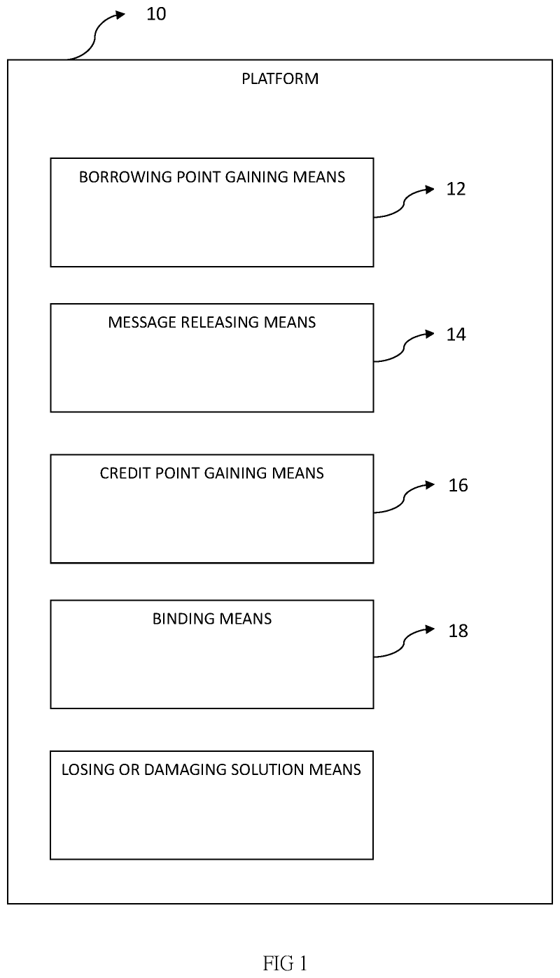

With reference to FIG. 1, a lending-borrower system in accordance with the present invention comprises a platform 10. The platform 10 may be an application program (APP) or a website. The platform comprises a borrowing point gaining means 12, a message releasing means 14, and a credit point gaining means 16. The borrowing point gaining means 12 is applied for providing borrowing points to a member of the platform 10 by depositing or transferring money. The platform 10 can get a part of the borrowing points from the member when the member gain the borrowing points as a commission. The member is not limited to a person, but also can be a company or a store. The message releasing means 14 is applied for any member to release a message for lending or borrowing an object. The credit point gaining means is applied for providing crediting points to each member of the platform 10. In addition, to keep illegally using or abusing the platform 10, a binding means 18 is provided for binding a qualification of each member by telephone number or e-mail and so on.

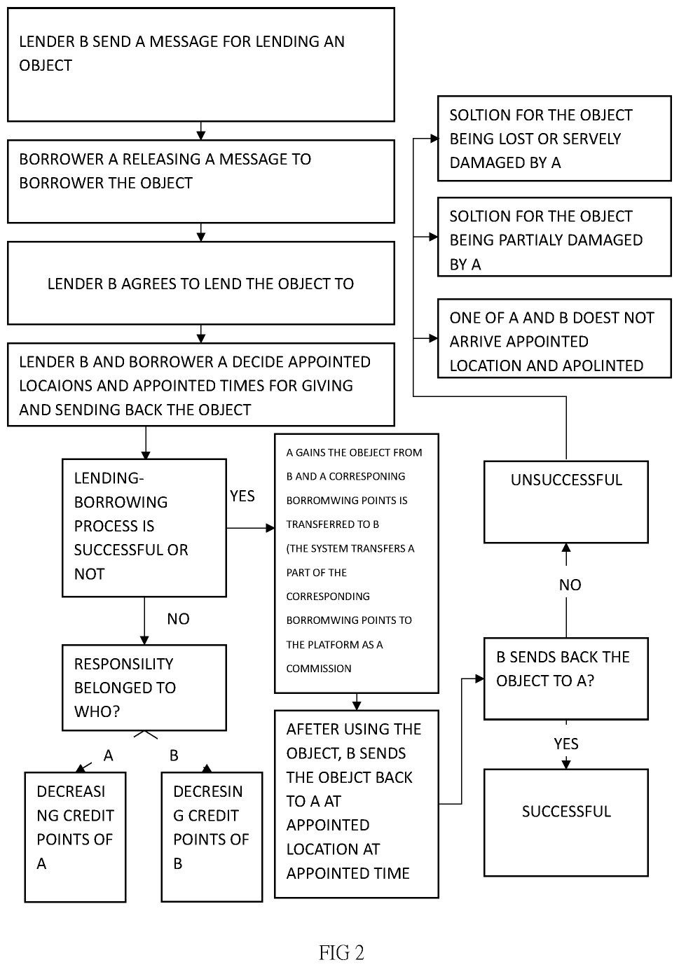

With reference to FIG. 2, when a lender B wants to lend an object to someone, the lender B can release a message to lend the object by the message releasing means 14 of the platform 10. If a borrower A wants to borrow this object and send a message by the message releasing means 14, the lender B can decide to lend this object to the borrower A or not based on the credit points of the borrower A. If the lender B decide to lend the object to the borrower A, they can appoint time and location for the lender B giving this object to the borrower A. If one of the lender B and the borrower A does not go to the appointed location at the appointed time or the object has some flaws, the lending-borrowing process is not done. At this time, the credit points of the one responsibility belonged to who causes this unsuccessful lending-borrowing process is decreased by the credit point gaining means 16, such as the lender B or the borrower A. If the lends B successfully give the object to the borrower A to achieve the lending-borrowing process, the borrowing point gaining means 12 transfers a corresponding borrowing points of the borrowers A to the lends B. In addition, the borrowing point gaining means 12 can take a part of the corresponding borrowing points to the platform 10 as a commission.

After the borrower A uses the object and wants to send the object to the lender B, the borrower A sends the object back to the lender B at an appointed location at an appointed time. If the borrower A successfully sends the object back to the lends B, the lending-borrowing process is done and the credit point gaining means 16 increasing the credit points of both of the lender B and the borrower A. If the lending-borrowing process cannot be finished, the lending-borrowing process is failed. At this time, the reason of causing fail of the lending-borrowing process has to be decided. If the object is lost or severely damaged by the borrower A, a losing or severely damaging solution is proceeded to transfer the borrowing points of the borrower A equal to the value of the object to the lender B and/or to decrease the credit points of the borrower A. If the object is partially damaged by the borrower A, a partially damaging solution is proceeded to transfer a corresponding borrowing points of the borrower A to the lender B and/or to decrease the credit points of the borrower A. If one of the lender B and the borrower A does not arrive the appointed location at the appointed time, a non-arrival solution is proceeded to decrease the credit points of the one who does not arrive the appointed location at the appointed time.

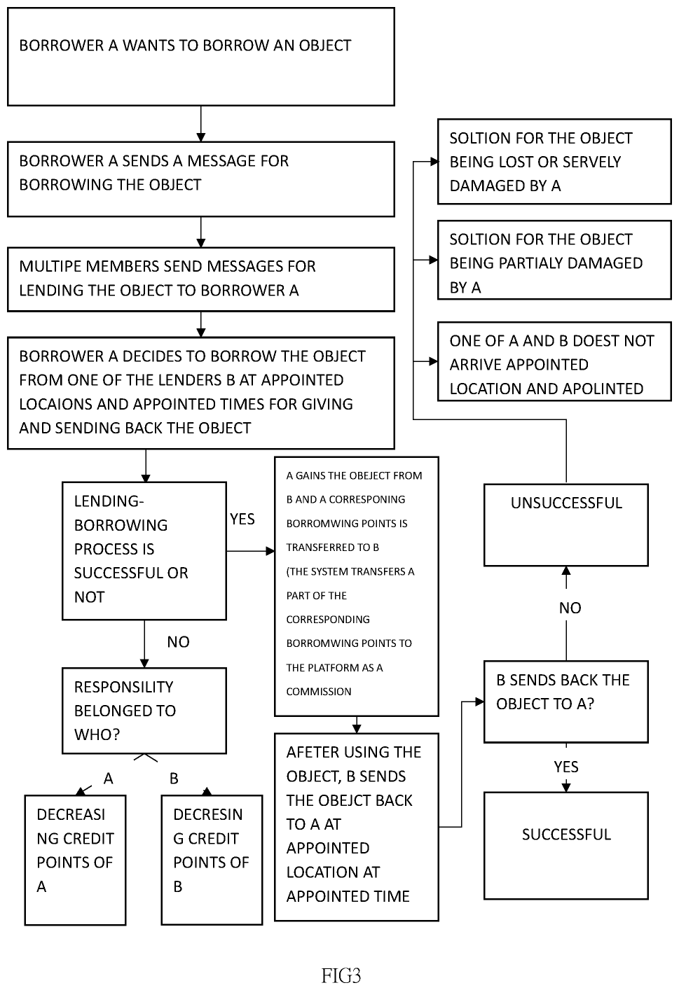

With reference to FIG. 3, when a borrower A wants to borrow an object from someone, the borrower A can release a message to borrow the object by the message releasing means 14 of the platform 10. If a lender B wants to lend this object based on the credit points of the borrower A and send a message by the message releasing means 14, they can appoint time and location for the lender B giving this object to the borrower A. If one of the lender B and the borrower A does not go to the appointed location at the appointed time or the object has some flaws, the lending-borrowing process is not done. At this time, the credit points of the one responsibility belonged to who causes this unsuccessful lending-borrowing process is decreased by the credit point gaining means 16, such as the lender B or the borrower A. If the lends B successfully give the object to the borrower A to achieve the lending-borrowing process, the borrowing point gaining means 12 transfers a corresponding borrowing points of the borrowers A to the lends B. In addition, the borrowing point gaining means 12 can take a part of the corresponding borrowing points to the platform 10 as a commission.

After the borrower A uses the object and wants to send the object to the lender B, the borrower A sends the object back to the lender B at an appointed location at an appointed time. If the borrower A successfully sends the object back to the lends B, the lending-borrowing process is done and the credit point gaining means 16 increasing the credit points of both of the lender B and the borrower A. If the lending-borrowing process cannot be finished, the lending-borrowing process is failed. At this time, the reason of causing fail of the lending-borrowing process has to be decided. If the object is lost or severely damaged by the borrower A, a losing or severely damaging solution is proceeded to transfer the borrowing points of the borrower A equal to the value of the object to the lender B and/or to decrease the credit points of the borrower A. If the object is partially damaged by the borrower A, a partially damaging solution is proceeded to transfer a corresponding borrowing points of the borrower A to the lender B and/or to decrease the credit points of the borrower A. If one of the lender B and the borrower A does not arrive the appointed location at the appointed time, a non-arrival solution is proceeded to decrease the credit points of the one who does not arrive the appointed location at the appointed time.

In addition, the borrowing points of the borrower A for borrowing the object can be transferred to the lender B when the object is sent back to the lender B.

Additionally, if the lending-borrowing process is unsuccessful due to non-arrival of one of the lender B and the borrower A, such as the borrower A does not arrive the appointed location, the arriving party, the lender B can inform the platform 10 to position the borrower A. If the non-arrival party does not arrive the appointed location or is not in contact with the platform 10 after several connections from the platform 10, the credit points of the non-arrival party is decreased. Furthermore, before the lending-borrowing process, the platform 10 provides the credit points of both sides to each other to make them to decide to proceed this lending-borrowing process or not.

Moreover, a member of the platform 10 may be a person, a company or a store. The lending-borrowing system can be applied to a lender B and a borrower A are both persons, such as a borrower A borrows a basketball from the lender B. The lending-borrowing system can also be applied to a lender B being a store and a borrower A being a person, such as a borrower A borrows a paint from a gallery for three months. The identity of each member of the system in accordance with the present invention is not limited.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A lending-borrowing system comprising:
a platform having multiple members and comprising
a borrowing point gaining means for providing borrowing points to each member and for transferring the borrowing points of one of the members to another one of the members when a lending-borrowing process is proceeding;
a message releasing means for one of the members to release a message for lending or borrowing an object; and
a credit point gaining means for providing a credit point to each member and increasing or decreasing the credit point of the member based on conditions.

2. The lending-borrowing system as claimed in claim 1, wherein the platform also has a losing or damaging solution means for proceeding the object being lost or damaged.

3. The lending-borrowing system as claimed in claim 1, wherein the borrowing point gaining means is also for transferring a corresponding borrowing points of a borrower to a lender when the lender successfully lends the object to the borrower and for transferring a part of the corresponding borrowing points to the platform as a commission.

4. The lending-borrowing system as claimed in claim 2, wherein the credit point gaining means is also for decreasing the credit points of the one responsibility belonged to who causes an unsuccessful lending-borrowing process.

5. The lending-borrowing system as claimed in claim 4, wherein the credit point gaining means is also for increasing the credit points of both of a lender and a borrower when a successful lending-borrowing process is done.

6. The lending-borrowing system as claimed in claim 5, wherein the borrowing point gaining means is also for transfer a part of borrowing points of each member to the platform as a commission when the member gains the borrowing points.

7. The lending-borrowing system as claimed in claim 3, wherein the credit point gaining means is also for decreasing the credit points of the one responsibility belonged to who causes an unsuccessful lending-borrowing process.

8. The lending-borrowing system as claimed in claim 7, wherein the credit point gaining means is also for increasing the credit points of both of a lender and a borrower when a successful lending-borrowing process is done.

9. The lending-borrowing system as claimed in claim 8, wherein the borrowing point gaining means is also for transfer a part of borrowing points of each member to the platform as a commission when the member gains the borrowing points.
